(19) United States
(12) Patent Application Publication
(10) Pub. No.: US 2015/0207301 A1
(43) Pub. Date: Jul. 23, 2015

(54) CIRCUIT BREAKER PANEL

(71) Applicant: Edison Global Circuits, LLC, Spring, TX (US)

(72) Inventors: Jeffery L. Franks, Tomball, TX (US); Ray Cole, Spring, TX (US); Stephen E. Williams, Tomball, TX (US)

(21) Appl. No.: 14/413,034

(22) PCT Filed: Jul. 22, 2013
(86) PCT No.: PCT/US13/51450

§ 371 Date: Jan. 6, 2015

Related U.S. Application Data
(60) Provisional application No. 61/675,498, filed on Jul. 25, 2012.
(60) Provisional application No. 61/735,172, filed on Dec. 10, 2012.

(51) Int. Cl. H02B 1/015

(52) U.S. Cl. CPC H02B 1/015

(57) ABSTRACT

A power delivery system includes a breaker panel. The breaker panel includes a plurality of circuit breakers and trip control circuitry coupled to each of the circuit breakers. The trip control logic receives a trip current value entered by a user for a selected one of the circuit breakers and a current measurement value from the selected one of the breakers. The trip control circuitry causes the selected one of the circuit breakers to trip in response to the current measurement value exceeding the trip current value.

### CROSS-REFERENCE TO RELATED APPLICATIONS

The present application claims the benefit of U.S. Provisional Applications Nos. 61/675,498, filed Jul. 25, 2012, and 61/735,172, filed Dec. 10, 2012, both of which are incorporated herein by reference for all purposes.

### FIELD OF INVENTION

The present invention relates in general to circuit breaker panels.

### BACKGROUND OF INVENTION

Circuit breaker panels are widely applied divide a power feed into a number of protected branch circuits. A panel may include many circuit breakers, each protecting a different branch circuit. Circuit breakers provide an automatic switching mechanism that responds to fault conditions (e.g., overload or short circuit) by interrupting continuity of a circuit to discontinue electrical flow. Arc-fault circuit interrupt (AFCI) and ground-fault circuit interrupt (GFCI) are newer circuit breaker technologies that respectively detect the fault conditions of arc-fault and ground-fault.

### SUMMARY OF INVENTION

Disclosed herein are methods and systems for providing dynamic control of tripping options for a plurality of circuit breakers. Also disclosed herein is a circuit breaker panel configuration that facilitates interaction between a user and the circuit breaker panel and/or between an electricity utility provider and the circuit breaker panel. Also disclosed herein is a circuit breaker panel configuration that enables multimedia/internet transmissions to be received via the circuit breaker panel. Additionally, at least some embodiments of the disclosed circuit breaker panel configuration provide an interface for communications between a user and electrical appliances powered via the circuit breaker panel.

In at least some embodiments, a circuit breaker panel provides overload protection for an eight branch circuit protection product. The circuit breaker panel may be a 60 ampere (Amp) service box with 20 Amp circuit breakers. The following items make up the basic foundation for the disclosed circuit breaker panel:
1) an electrical panel box providing 60 Amp, single phase service, 120 VAC/240 VAC 50/60 Hz;
2) branch circuit over-current protection devices (circuit breakers) that have a remote trip capability;
3) circuit breakers that provide stand-alone circuit protection based upon bi-metal/magnetic trip actuation;
4) sensors that are integrated into the circuit breakers for ground fault event detection and/or arc fault event detection;
5) circuit breakers that are single pole devices rated for 120 VAC/240 VAC, 50/60 Hz, 20 Amp;
6) circuit breakers that fit into a plastic enclosure (referred herein as a “circuit breaker nest”) designed to hold up to eight circuit breakers;
7) electrical bus bars and shunt measurement sensors that are integrated into a measurement and control board described herein which may be located in the circuit breaker nest;
8) circuit breakers that make connection to the line-side electrical bus bars without exposure to the user; and
9) circuit breakers that mate with remote sensing and control connectors located on the measurement and control board.

The items listed above can be tested as a stand-alone system to provide basic branch circuit over-load protection. This configuration is not dependent on use the measurement and control board described herein except for those elements that make up the bus bar system and main electrical connections. Various auxiliary features may be added to the branch circuit over-protection configuration of the circuit breaker panel. These auxiliary features include:
1a) the circuit breaker nest is improved to include two fully populated circuit boards (a measurement and control board, and a system controller board) for control, measurement, sensing, and user interface options;
1b) smart circuit breaker functionality is utilized to implement Ground-Fault Circuit Interrupt (GFCI) and Arc-Fault Circuit Interrupt (AFCI) capability);
2) the measurement and control board, and the system controller board are sealed inside the nest such that they become tamper proof;
3) the measurement and control board provides high quality electrical utility metrology functions for total power and also enables branch circuit measurement/control to become functional;
4) the system controller board provides the Human Machine Interface (HMI) using a display (e.g., a TFT touch screen);
5) the display has an integrated touch screen that is utilized to setup and observe auxiliary features that specialize each branch circuit;
6) the display provides status, time, power measurement information, plus a means for testing auxiliary functions;
7) the display shows circuit events, fault detection, and fault characterization (e.g., over-current, ground-fault, arc-fault, line spikes, brown- out, quality of power);
8) use of the HMI for setup by installation personnel to add functionality such as branch circuit characterization (name, usage, etc.), branch circuit prioritization, and branch circuit enabled features (GFCI, AFCI, etc.).

In at least some embodiments, the disclosed circuit breaker panel (e.g., using the system controller board) provides a gateway into the home from a communications provider. This can be by means of a hard copper connection, fiber optics, cell tower, or proprietary WAN. Protocols handle remote logging and control by means of the communications connectivity, irrespective of the connecting means. One implementation of the communications gateway is by use of a communications module that is supplied by the communications provider. This communication module connects to the system controller board, for example, via a USB 2.0 connection. In at least some embodiments, the communications module is set up by the provider in order to complete a radio frequency (RF) interface compatible with cell tower protocols. This equipment provides at least 3G and possibly 4G service, if available. This communication module is mounted on the outside of the house and connects to the system controller board via a USB 2.0 cable through the wall of the house.

Some of the communication features supported by the disclosed circuit breaker panel are as follows: 1) provide high-speed streaming services (WAN); 2) route communications to end-point appliances in a Home Area Network (HAN) via the system controller board; 3) provide functionality for VoiP, streaming video, streaming audio and/or internet connectivity; 4) provide connectivity from/to the electric utility provider; 5) add utility provider functionality for remote meter reading, control of power to the residence (turn power on or off), demanding side power control (control branch circuits based on priority and usage), provisioning time-of-use metrology information, supporting VPN and SCADA protocols to secure the connections and communications platform and format that the electric utility provider uses, supporting supervisory protocols whereby information can be sent either direction, supporting use of supervisory information for multiple purposes, none of which are mutually exclusive of each other (e.g., for logging, metering and/or control); 6) use of the HMI for setup by a communications provider and/or an electric utility provider; 7) user of the HMI for communications setup (e.g., routing, IP address, GPS co-ordinates, SIM setup, credentials, VPN, and elements of the Home Area Network (HAN)); 8) use of the HMI for electric utility setup (e.g., customer account number, credentials, VPN, SCADA setup); and 9) end-point wireless connectivity to devices inside the house is accomplished by means of sub-boards (WiFi and/or ZigBee communication boards) that are attached to the system controller board. The sub-boards provide various features as follows: 1) the system controller board contained in the circuit breaker nest is configured with the appropriate sub-board(s) to enable additional end-point wireless communications inside the house; and 2) various end-point communications are supported including: VoiP (telephone), streaming audio (music), streaming video (TV), internet connections (laptop computer), and smart-box connections (laptop computer).

Some embodiments of the disclosed circuit breaker panel include a cellular base station. The cellular base station allows the circuit breaker panel to serve as an access point to a cellular wireless data network (e.g., a GSM, LTE, or other cellular wireless communication network). Thus, the breaker panel may provide an access point for a micro-cell or a pica-cell of a cellular network. Such a breaker panel may inter-communicate with other cellular base station breaker panels to form a mesh network. Thus, embodiments of the breaker panel may alleviate the need to install conventional cell towers.

Embodiments of the disclosed circuit breaker panel may also include nuisance trip prevention logic. Conventional breakers may open in response to conditions that may not represent actual arc or ground fault events. For example, conventional arc-fault-circuit-interrupters and ground-fault-circuit-interrupters are susceptible to false trips from electromagnetic impulse. Typically, lightening can cause either type of circuit element to nuisance-trip, requiring human intervention to reset. Embodiments of the disclosed circuit breaker panel include switches, such as latching relays, that may be opened on detection of a nuisance fault event and closed based on a determination that the fault event has passed. Thus, embodiments provide the protection associated with opening a breaker while eliminating the inconvenience of having to manually reset a tripped breaker. If analysis of a fault event indicates that an actual fault is likely occurring (i.e., an actual arc or ground fault), then embodiments trip a breaker associated with the branch circuit in which the fault is detected and require that the breaker be manually reset.

### BRIEF DESCRIPTION OF DRAWINGS

For a more complete understanding of the present invention, and the advantages thereof, reference is now made to the following descriptions taken in conjunction with the accompanying drawings, in which:

FIG. 1 shows a representative circuit breaker system in accordance with an embodiment of the disclosure;

FIG. 2 shows a representative circuit breaker system in accordance with another embodiment of the disclosure;

FIG. 3 shows a block diagram of a representative circuit breaker in accordance with an embodiment of the disclosure; and

FIG. 4 shows a method of controlling a circuit breaker system in accordance with an embodiment of the disclosure.

### DETAILED DESCRIPTION OF THE INVENTION

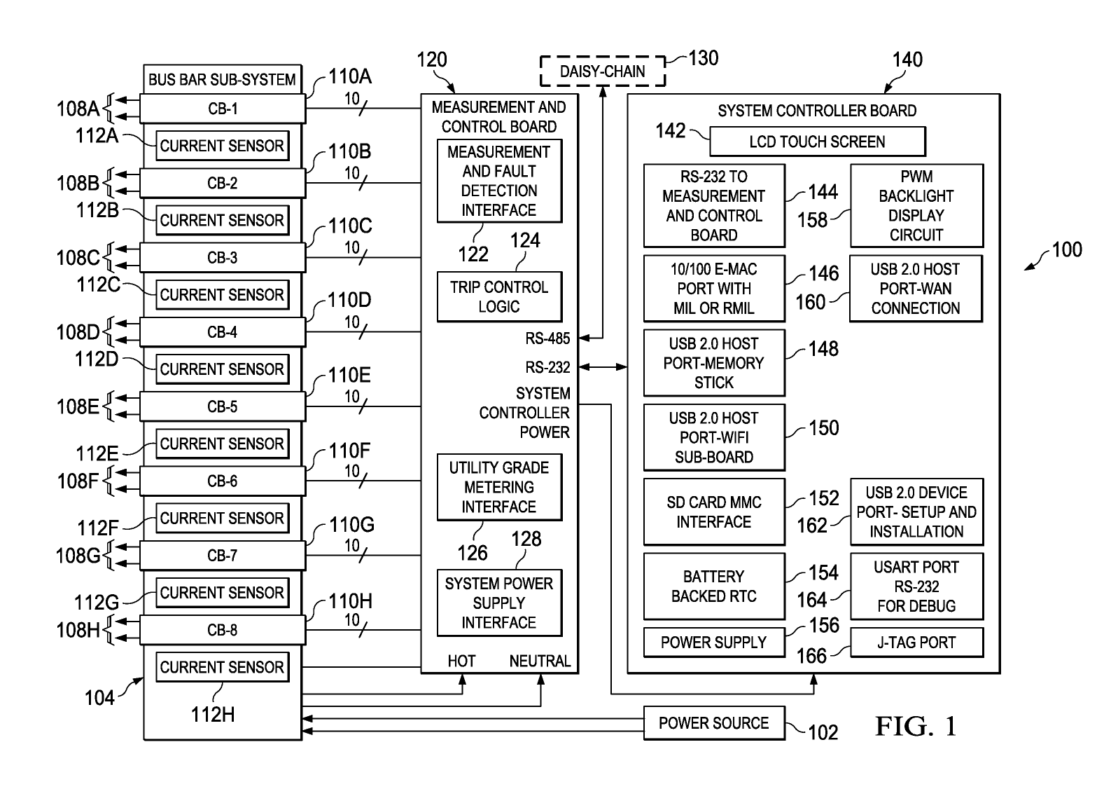

The principles of the present invention and their advantages are best understood by referring to the illustrated embodiment depicted in FIGS. 1-4 of the drawings, in which like numbers designate like parts. Certain terms are used throughout the following description and claims to refer to particular system components. As one skilled in the art will appreciate, individuals and companies practicing in the art may refer to a particular component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

FIG. 1 shows a system 100 in accordance with an embodiment of the disclosure. As shown, the system 100 comprises a plurality of circuit breakers 11OA-11OH coupled to a bus bar sub-system 104. For each circuit breaker 11OA-11OH, current sensor logic 112A-112H is also provided. Each circuit breaker 110A-110H provides fault protection for a corresponding branch circuit 108A-108H that receives power from power source 102.

In FIG. 1, each circuit breaker 110A-110H couples to trip control logic 124. In at least some embodiments, the trip control logic 124 is mounted to a measurement and control board 120. The measurement and control board 120 includes, for example, a measurement and fault detection interface 122 through which power sense signals and fault sense signals are received from the circuit breakers 11OA-11OH.

The trip control logic 124 operates to provide a default (e.g., overload) tripping option, an arc-fault circuit interrupt (AFCI) tripping option, a ground-fault circuit interrupt (GFCI) tripping option, and a AFCI/GFCI tripping option for each of the circuit breakers 110A-110H. In at least some embodiments, the tripping option for each circuit breaker 110A-110H is selectable by a user via a user interface (e.g., touch screen 142) in communication with the trip control logic 124. The tripping option for each circuit breaker 11OA-11OH could also be selected via a local or remote computing device configured to communicate with the trip control logic 124.

As shown, the measurement and control board 120 also comprises utility grade metering logic 126 that determines power consumption information for the system 100 and that organizes, formats, and selectively transmits the power consumption information to a utility metering collection site (not shown). The measurement and control board 120 also comprises a power supply interface 128 that outputs different voltage levels for different components of the system 100. For example, the trip control logic 124 and the utility grade metering logic 126 may operate using different voltage levels. The power supply interface 128 also may provide power to components of a system controller board 140 in communication with the measurement and control board. In at least some embodiments, the measurement and control board 120 and the system controller board 140 communicate via a RS-232 interface. Further, multiple measurement and control boards 120 may be daisy-chained 130 (e.g., via a RS-485 interface) as needed to support additional circuit breakers. In this manner, the total number of circuit breakers in the system 100 can be extended as needed by replicating the measurement and control board 120 operations (trip control loop functionality) for additional circuit breakers. Even if the number of measurement and control boards 120 increases, only one system controller board 140 need be used for system 100.

As shown, the system controller board 140 comprises a touch screen 142 (e.g., a TFT touch screen or other touch screen technology). The touch screen 142 displays information to a user and also enables a user to interact with control features of the system 100 and/or to request information regarding the system 100. For example, the system 100 may display trip information indicating a cause of a breaker trip (e.g., overcurrent, ground fault, arc fault, trip command reception, etc.). Information indicating whether a tripped breaker can be reset may also be displayed. For example, if the system 100 determines that an attempted reset of a tripped breaker will be ineffectual (e.g., the trip cause has not been corrected, an open circuit time interval has not expired, etc.), then the system 100 may display an indication that the tripped breaker cannot currently be reset. As previously mentioned, a user/administrator should be able to set (and dynamically update) a default tripping option, an arc-fault circuit interrupt (AFCI) tripping option, a ground-fault circuit interrupt (GFCI) tripping option, and a AFCI/GFCI tripping option for each of the circuit breakers of system 100. The system controller board 140 also comprises a pulse width modulation (PWM) backlight display circuit 158 that enables adjustment of the backlight intensity used to illuminate the touch screen 142.

The system controller board 140 also comprises several communication interfaces including: a RS-232 interface 144 to support communications with the measurement and control board 120; a 10/100 E-MAC port 146 with media independent interface (MiI) or reduced media independent interface (RMII); a USB 2.0 host port 148 with memory stick compatibility; a USB 2.0 host port 150 for optional communications to a WiFi daughter board; a Secure Digital (SD) card multimedia card (MMC) interface 152; a USB 2.0 host port 160 for Wide Area Network (WAN) connectivity; a USB 2.0 device port 162 for setup and installation of control software/firmware of the system 100; a universal asynchronous receiver/transmitter (USARD) port 164 compatible with RS-232 for debugging control software/firmware of the system 100; and a J-TAG port 166 for test and debug operations. The system controller board 140 also comprises a power supply interface 156 to adjust power supply voltage levels for different components of the system controller board 140. Further, the system controller board 140 comprises a battery-backed real-time clock (RTC) 154 to clock various hardware components of the system controller board 140.

The components of the measurement and control board 120 and the system controller board 140 are examples only and are not intended to limit embodiments of the disclosure to particular communication interfaces or control schemes. In general, each measurement and control board 120 provides a trip control loop for up to a predetermined number of circuit breakers (e.g., 8 circuit breakers). The trip control loop is implemented with circuit breakers that are able to sense all fault conditions that could be used to trigger tripping of a circuit breaker. In order to customize the tripping conditions for circuit breakers that are able to detect a plurality of fault conditions, the fault sense signals and power sense signals detected by the circuit breakers are passed to the trip control loop, which manages the specific trip conditions for each circuit breaker separately. In this manner, the tripping conditions for each of a plurality of circuit breakers (e.g., 110A-110H), providing fault protection for different branch circuits (e.g., branch circuits 108A-108H), can be customized and updated as needed.

Meanwhile, the system controller board 140 provides user interface options and communication features that enhance the role of a circuit breaker system or panel. For example, the user interface features of system controller board 140 are used to provide power consumption information, appliance management, and circuit breaker management to a user/administrator of the system 100. Meanwhile, the communication features of system controller board 140 enable testing, debugging, endpoint communications with appliances, communications with electrical receptacles and/or receipt of multimedia services (e.g., Internet, VOIP, television, streaming radio/audio, etc.) for a home area network (HAN).

In some embodiments, the trip control loop components of measurement and control board 120 could be combined with the user interface features and/or the communication features of system controller board 140 on a single control board. In general, the trip control loop components, the user interface features and the communication features described herein could be spread across multiple control boards in different ways without changing the operations of system 100. Further, the user interface features and the system controller board 140 described herein does not exclude the possibility of managing features of the system 100 using a separate computer system or portable control device configured to communicate with control logic of the system 100. In other words, a user/administrator of system 100 could manage features of the system 100 using a pre-integrated user interface (e.g., touch screen 142), a separate user interface (e.g., a computing device running appropriate software), or both.

In at least some embodiments, the management of features for system 100 could be divided into user-managed features and administrator-managed features. In other words, there may be features of system 100 that only an end user (e.g., a home owner) should be able to access. For example, a user may select color and style options for the HMI, enable/disable an audible notification for non-critical events (advertisements), set feedback criteria regarding power consumption for branch circuits and the entire system. Furthermore, there may be other features of system 100 that only a system installer (e.g., an electrical contractor) should be able to access. For example, the system installer can name the branch circuits, set priorities for branch circuits and/or set tripping options (trip current level, trip time interval, GFI, AFI, etc.) for each branch circuit. Furthermore, there may be other features of system 100 that only a communication provider should be able to access. For example, the communication provider sets up time zone information, GPS coordinates, network time protocols, VPN options, authentication credentials for the communication provider, enable/disable features of the system (fire/police/emergency response options). Furthermore, there may be other features of system 100 that only an electric utility provider should be able to access. As an example, an electric utility provider may set up account numbers, SCADA access information, credentials for later access (username/password), routing information for communications (e.g., VPN options).

The system 100 may verify authority to access features of the system 100 by requiring entry of an authorization code, presentation or attachment of an authorization key device, or other authentication means. For example, an authorization key device may be connected to a USB port of the system 100. The system 100 may read information, such as encrypted security information, from the key device that identifies the management operations the user of the key device is authorized to perform. For example, a licensed electrician may connect a first key device to gain access to electrical control features of the system 100, while a communications company representative may connect a second key device to the system 100 to access communication features of the system 100. If the device, authorization code, etc. fails to provide proper security credentials, then the system 100 may inhibit feature changes. Access to at least some end-user configurable features may be provided without use of an authentication means.

The system 100 may record and store information indicative of the operations performed with respect to each key device, authorization code, or other authentication means. The system 100 may also transfer the stored information to a system (e.g., a central control system) associated with the authentication means and the features accessed via the authentication means. For example, for a key device authorizing access to electrical features, the system 100 may transfer stored information identifying the key device and information indicative of operations performed via authorization of the key device to a control system associated with or maintained by the electric utility company. If the control system determines that the operations performed were not authorized, then the control system may reverse or cause the system 100 to reverse the operations thereby returning the system 100 to a pre- operation state (i.e., the operations performed via the authorization means may be unwound). In some embodiments, the system 100 may contact the control system with regard to the authentication means to determine authority, permissions, etc. after detection of the authentication means and prior to allowing access to features associated with the authentication means.

In at least some embodiments, the electric utility provider is able to access system 100 remotely to collect power consumption information and/or to selectively trip circuit breakers of system 100. In at least some embodiments, if the electric utility provider trips a circuit breaker, the trip control logic 124 causes the circuit breaker to continue tripping (manually resetting of the circuit breaker switch is ineffective) until the electric utility provider signals to the trip control logic 124 that use of the tripped circuit breaker is allowed. In this manner, the electric utility provider can prevent misuse of the system 100, or even misuse of individual circuit breakers and their corresponding branch circuits.

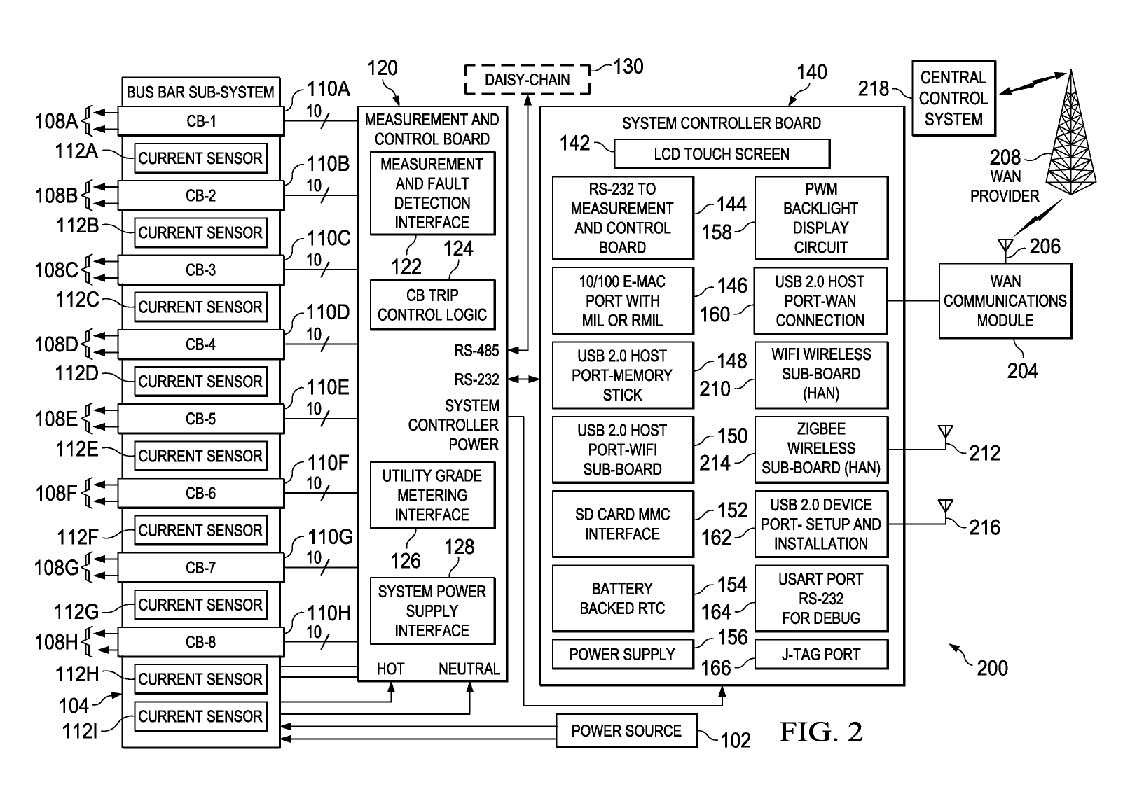

FIG. 2 shows a system 200 in accordance with another embodiment of the disclosure. The system 200 of FIG. 2 is similar to the system 100 of FIG. 1, but shows additional communication features. In FIG. 2, the system 200 comprises a WAN communications module 204 with antenna 206 coupled to the USB 2.0 host port 160 for Wide Area Network (WAN) connectivity. In this manner, the WAN communication module 204 and antenna 206 enable communications with WAN provider 208.

In some embodiments, the WAN communications module 204 comprises logic (e.g., circuitry and instructions) that allow the WAN communications module 204 to operate as a cellular base station for a micro-cell, a pico-cell etc. For example, the range of a microcell may be less than two kilometers, while the range of a pico-cell may be about 200 meters or less, and the range of a femto-cell may be about 10 meters. The WAN communications module 204 may implement a cellular base station in accordance with, for example, the Global System for Mobile Communications (GSM), Long Term Evolution (LTE), or other wireless communication standard. Thus, the WAN communications module 204 may allow a circuit breaker panel including the system 200 to operate as a micro cell tower. Instances of the system 200 geographically distributed in different circuit breaker panels may wirelessly communicate and form a mesh network that provides a wide area wireless network. Thus, embodiments may extend the availability of wireless communications over a large geographic area without requiring installation of conventional cell towers.

System 200 also shows the addition of a WiFi wireless sub-board 158 with antenna 160 to the system controller board 140. The WiFi wireless sub-board 158 enables communications for home area network (HAN) services. System 200 also shows the addition of a ZigBee wireless sub-board 162 with antenna 164 to enable communications with compatible electrical appliances and receptacles.

Some embodiments of the system 200 may provide communication via multiple WLAN channels. For example, communication such as telephone services, entertainment services, etc. related to an end user of the breaker panel may be provided via a first WLAN channel (i.e., a public channel), and communications related to utility company access to the breaker panel may be provided via a second WLAN channel (i.e., a private channel). Each channel may be associated with a subscriber identity module (SIM card) coupled to the breaker panel. The SIM card associated with the public channel may be procured by the end user, for example, from any source providing the associated end user communications. The SIM card associated with the private channel may be unique to the utility company and not publically available. The private channel SIM is configured for communication only with the servers of a utility company central control system. The telecommunication entity providing the private channel recognizes the private channel SIM card and routes all communication on the private channel to the utility company servers. Communication on the private channel may be via a virtual private network (VPN) between the breaker panel and the utility company servers. If the private channel SIM card is removed from the breaker panel, then the system control board 140 may disable breaker panel operation (e.g., open the circuit breakers 110 to disable power delivery). The private channel SIM card may not be usable to provide communication for devices other than the breaker panel because the private channel SIM card provides communication only with the utility company servers, and the VPN coding, protocols, and security certificates used for communication via the private channel are known only to the breaker panel and the utility company servers.

Internet protocol (IP) communication between the breaker panel and the utility company servers via the private channel may be initiated by either of the breaker panel and the utility company servers. While the private channel IP address of the breaker panel may be dynamically changed, the utility company servers may connect with the telecommunication entity servicing the private channel to determine what IP address is associated with the private channel SIM card at any particular time. The utility company servers may initiate communication with the breaker panel using the obtained IP address. Alternatively, if the utility company server desires to communicate with the breaker panel, but is unable to obtain the private channel IP address of the breaker panel prior to initiation of communication, the server communicate with the breaker panel via a side channel (e.g., via a text message) to request that the breaker panel initiate IP protocol communication with the server.

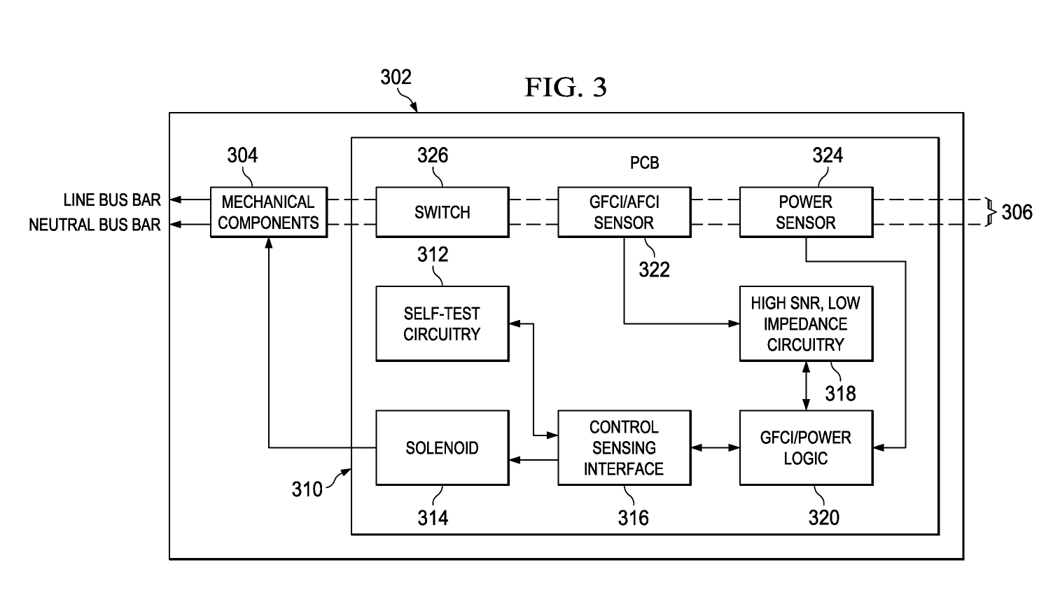

FIG. 3 shows a block diagram of a circuit breaker 302 in accordance with an embodiment of the disclosure. The circuit breaker 302 may be equivalent to and applied as the circuit breakers 110A-H. The circuit breaker 302 comprises mechanical components 304 that selectively break continuity of a branch circuit 306. The mechanical components 304 include a switch (e.g., a latching relay, a relay, a semiconductor switch, or other suitable power switching device). In at least some embodiments, the mechanical components 304 couple to a line bus bar and a neutral bus bar without wires (i.e., direct contact between conductors corresponding to the at least some of the mechanical components 306 and with both the line bus bar and the neutral bus is made possible). The mechanical components 304 are activated by a solenoid 314 that can be triggered using electrical control signals. Once the mechanical components 304 are “tripped” (breaking the continuity of branch circuit 306) by energizing the solenoid 314, the mechanical components 304 have to be manually reset to restore continuity to the branch circuit 306. In some embodiments, the switch may be opened and closed automatically by the trip control logic 124. That is, the trip control logic 124 may automatically restore continuity of the branch circuit, rather than requiring manual resetting.

In at least some embodiments, the circuit breaker 302 comprises GFCI/AFCI sensors 322 and power sensor 324 in-line with the branch circuit 306. The GFCI/AFCI sensors 322 is configured to provide fault sense signals to GFCI/power logic 320 via high signal-to-noise ratio (SNR), low impedance circuitry 318. The high SNR, low impedance circuitry 318 improves the performance of fault detection for circuit breaker 302. Meanwhile, the power sensor 324 provides power sense signals directly to GFCI/power logic 320. With the power sense signals from the power sensor 324 and the fault sense signals from the GFCI/AFCI sensor 322, the GFCI/power logic 320 is able to identify faults including overload faults, AFCI faults and GFCI faults. If GFCI/power logic 320 identifies a fault, a corresponding fault signal is output by the GFCI/power logic 320. Instead of energizing the solenoid directly based on the fault signal output by GFCI/power logic 320, the circuit breaker 320 causes any fault signals output by GFCI/power logic 320 to be diverted to control sensing interface 316, which carries fault signals output by the GFCI/power logic 320 to a trip control loop (e.g., the trip control logic 124 on measurement and control board 120). The trip control logic 124, outside of the circuit breaker 302, determines whether to trip the circuit breaker 302 depending on the tripping option (e.g., a default (e.g., overload) tripping option, an AFCI tripping option, a GFCI tripping option, and a AFCI/GFCI tripping option) selected for the selected for the circuit breaker 302. The tripping option for the circuit breaker 302 can be adjusted as needed (external to and separate from the fault detection capabilities of the circuit breaker 302) by configuring the trip control logic 124. In other words, the circuit breaker 302 is able to detect fault conditions for all of the tripping options available, but it is the trip control loop (external to the circuit breaker 302) that determines whether to ignore a detected fault or to trip the mechanical components 304 in response to a detected fault.

For example, the trip control logic 124 (external to the circuit breaker 302) may be set to cause the circuit breaker 302 to operate using the default tripping option. With the default tripping option, all fault conditions (overload, AFCI, GFCI) detected by the GFCI logic 320 will be diverted to the trip control logic 124. In response, the trip control logic 124 will cause the solenoid 312 to be energized for overload detection, but not for AFCI detection nor for GFCI detection. With the AFCI tripping option, all fault conditions detected by the GFCI logic 320 will be diverted to the trip control logic 124. In response, the trip control logic 124 will cause the solenoid 312 to be energized for overload detection or for AFCI detection, but not for GFCI detection. With the GFCI tripping option, all fault conditions detected by the GFCI logic 320 Will be diverted to the trip control logic 124. In response, the trip control logic 124 will cause the solenoid 312 to be energized for overload detection or for GFCI detection, but not for AFCI detection. With the AFCI/GFCI tripping option, all fault conditions detected by the GFCI logic 320 will be diverted to the trip control logic 124. In response, the trip control logic 124 will cause the solenoid 312 to be energized for overload detection, for AFCI detection, or for GFCI detection.

In some potential fault situations, the tripping control logic 124 may automatically open and close the switch included in the mechanical components 304 that control current flow in a branch circuit rather than opening the switch and requiring manual reset. (i.e., tripping the breaker). Such operation is advantageous in that if a transitory indication of a potential fault is detected, then the switch can be opened and closed when the fault has passed with no need to manually reset the breaker. Thus, embodiments avoid the inconvenience of having to manually reset the breaker 302 when transitory nuisance faults occur.

The trip control logic 124 may monitor the current flowing in each circuit branch for potential arc fault events that are transitory in nature (i.e. nuisance arc faults). The trip control logic 124 may analyze the signature of the current flowing in a branch circuit to identify a potential arc fault condition. For example, the trip control logic may compare a branch circuit current signature to a predetermined arc fault current signature. Based on the comparison, the trip control logic 124 may determine the statistical probability of the event being an arc fault. If a potential arc fault is detected, then the trip control logic 124 may cause the switch included in the mechanical components 304 to open (this is not a trip, but disables the branch circuit temporarily). After the event has passed, the trip control logic 124 may automatically close the switch. Embodiments of the trip control logic 124 may apply a sliding window statistical match algorithm that is history/time based. If there is a recurrence of an arc-fault event at higher interval rates, then the trip control logic 124 may extend the time that the switch is open. If there is a high statistical probability of a true arc-fault condition based on history/time, then the trip control logic 124 may trip the breaker (i.e., open the switch and require manual reset). Thus, embodiments provide arc fault nuisance trip prevention that may be selectably enabled and disabled.

Similarly, the trip control logic 124 may monitor the ground current for potential ground faults events that are transitory in nature (i.e. nuisance ground faults). If a potential ground fault event is detected, the trip control logic 124 may cause the switch included in the mechanical components 304 to open. After the event has passed, the trip control logic 124 may close the switch. Embodiments of the trip control logic 124 may apply a sliding window statistical match algorithm that is history/time based. If there is a recurrence of a ground fault event at higher interval rates, then the trip control logic 124 may extend the time that the switch is open. If there is a high statistical probability of a true ground fault condition based on history/time, then the trip control logic 124 may trip the breaker (i.e., open the switch and require manual reset). Thus, embodiments provide ground fault nuisance trip prevention that may be selectably enabled and disabled.

Because the trip control logic 124 can, in lieu of or in conjunction with the circuit breaker itself, determine whether and/or when the circuit breaker trips to open the branch circuit associated with the breaker, the current level at which the circuit breaker trips can be varied by the trip control logic 124. Consequently, the circuit breaker 302 can limit current flowing through a branch circuit to any level less than or equal to a maximum current level specified for the breaker 302. For example, if the breaker 302 is specified for use at a maximum trip current level (e.g.,. 20 Amps, 200 Amps, or other amperage), then the trip control logic 124 may cause the breaker 302 to trip at any current level less than or equal to specified maximum trip current level Amps (e.g., 5, 10, 15 Amps, etc.). Consequently, breakers of fewer different current ratings are needed to populate a breaker panel which may reduce overall cost. The current level at which a breaker 302 trips may be provided to the trip control logic 124 by authorized personnel, such as authorized service personnel (e.g., a licensed electrician), power utility personnel, etc. The trip current level for a breaker 302 may be entered by authorized personnel via an entry device associated with the breaker panel, such as the touch screen 142, or a user interface device communicatively coupled to the breaker panel via a wired or wireless network.

In addition to providing variable trip current level, the trip control logic 124 can control when the breaker 302 trips. The trip control logic 124 monitors the current flowing through the breaker 302. When the current flowing through the breaker exceeds the trip current level assigned to the breaker for a predetermined trip time interval, the trip control logic 124 can cause the circuit breaker 302 to trip and open the branch circuit associated with the breaker 302. The trip interval time may be provided to the trip control logic 124 by authorized personnel, such as authorized service personnel (e.g., a licensed electrician), power company personnel, etc. The trip interval time for a breaker 302 may be entered by authorized personnel via an entry device associated with the breaker panel, such as the touch screen 142, or a user interface device communicatively coupled to the breaker panel via a wired or wireless network.

Examples of interaction between the trip control logic 124 and the breaker 302 include:
1) The trip control logic 124 is configured to not cause the breaker 302 to trip, and consequently, tripping of the breaker 302 when the rated current of the breaker 302 is exceeded is controlled by the actuation components (magnetic, bi-metal, etc.) of the breaker 302.
2) The trip control logic 124 is configured to cause the breaker 302 to trip at a current that is lower than the rated current of the breaker 302.
3) The trip control logic 124 is configured to trip the breaker 302 at the rated current of the breaker 302 with faster response than is provided by the actuation components (bi-metal, magnetic, etc.) included in the breaker 302.
4) The trip control logic 124 is configured to prevent nuisance tripping by opening a switch (e.g., a latching relay) in the breaker 302, and disabling current flow through the breaker 302, before the actuation components in the breaker 302 can respond. The trip control logic 124 may close the switch, and re-enable current flow through the breaker 302, when the nuisance condition has been corrected.

As shown, the circuit breaker 302 also comprises self-test circuitry 312 coupled to the control sensing interface 316. The self-test circuitry 312 enables test signals to be sent to the trip control logic 124 via the control sensing interface to test the overall functionality of the circuit breaker 302 and the trip control logic 124. The self-test circuitry 312 is operated by pressing a button or other contact accessible on the outer surface of the circuit breaker 302. The outer surface of the circuit breaker 302 also includes contact points (e.g., slide connectors and/or screws connectors) for the line bus bar and the neutral bus bar.

To summarize, system 100 describes a control system for a circuit breaker panel. The control system is divided such that fault detection logic is provided within each circuit breaker and trip control logic is provided external to each circuit breaker. In at least some embodiments, the fault detection logic within each circuit breaker is able to detect an overload condition, an AFCI condition, and a GFCI condition. Meanwhile, the trip control logic external to each circuit breaker is able to provide a default tripping option (overload only), an AFCI tripping option (overload and AFCI only), a GFCI tripping option (overload and GFCI only), and a AFCI/GFCI tripping option (overload, AFCI, and GFCI) in response to detected faults.

The control system for a circuit breaker panel also may comprise a user interface in communication with the trip control logic. The user interface enables a user to view power consumption information for the circuit breaker panel and/or to adjust each of the plurality of circuit breakers to operate with one of the default tripping option, the AFCI tripping option, the GFCI tripping option, and the AFCI/GFCI tripping option. The control system for a circuit breaker panel also may comprise a utility metering interface coupled to the plurality of circuit breakers. The utility metering logic selectively transmits power consumption information for the circuit breaker panel to a utility company and may enable the utility company to selectively disable each of the circuit breakers. The control system for a circuit breaker panel also may comprise a networking interface that provides multimedia features for a home area network (HAN) and/or an endpoint communications interface that enables communications between appliances/receptacles and the circuit breaker panel.

The number of circuit breakers in a circuit breaker panel box may vary according to the size of the home/business for which the circuit breaker panel box is intended and/or government regulations. In accordance with at least some embodiments, the circuit breaker panel box models may have 4, 6, 8, 12, 16, 20, 40 or more circuit breakers. As the number of circuit breakers includes, the amount of trip control loop circuitry also increases. In other words, the trip control loop circuit described herein may implement a control chip compatible with a predetermined number of circuit breakers (e.g., 8). If the number of circuit breakers is greater than the predetermined number, the number of control chips is increased. As needed, multiple control chips may be daisy-chained with regard to communications being received to the circuit breaker panel box or communications being transmitted from a circuit breaker panel box.

Embodiments of circuit breaker panel boxes may vary with respect to the number of circuit breakers, the positioning of circuit breakers (e.g., vertical or horizontal), the use of a display and/or LEOs, the size and location of a display, the software configuration, the cross bar position/shape, the use of a meter, the location of the meter, the use of an antenna for wireless communications, the wireless frequency and protocol, and the ability to communicate with utility company devices for measurements, logging, and remote control of circuit breakers. In some embodiments, the various features of a circuit breaker panel box are available for selection by a customer, but not required. Further, the selection of AFCI and/or GFCI is optional for each circuit breaker.

In some embodiments, the control circuitry of a circuit breaker panel box is capable of supporting all the features described herein. However, not all the features need be selected by each customer and thus the implementation of circuit breaker panel boxes may vary. Further, a customer may later decide to upgrade circuit panel boxes (e.g., add a display, upgrade software, add wireless communications, etc.) without having to replace the entire circuit breaker panel box.

In some embodiments, TV, Ethernet and/or Cable will be able to connect to the circuit breaker panel box without regard to the utility company. For example, plugs/ports and related protocols may be implemented with the circuit breaker panel box to achieve this added functionality. Further, the communications for TV, Ethernet and/or Cable may be accomplished via the power line or wireless hardware/protocols. In the home/business, an appropriate adapter/modem may be implemented to convert signals as needed.
In accordance with at least some embodiments, circuit breaker panel box embodiments are configured to provide one or more of:
1) a design that enables circuit breakers to plug into both the hot (line) and neutral bus bars without wires;
2) a touch screen;
3) programmability so that voltage and safety requirements (e.g., GFCI/AFCI) can be programmed into each circuit breaker from a user interface in the circuit breaker panel box;
4) mitigation of shock from a live wire;
5) enabling an end user to monitor power consumption per appliance in real-time;
6) the ability to program GFCI and AFCI on all wired pathways;
7) programmability of appliance consumption at the circuit breaker panel box or remotely; 8) an automatic soft start feature that eliminates spikes in power during restart.

In accordance with at least some embodiments, each circuit breaker is configured to provide one or more of:
1) eliminate separate metering and related maintenance costs;
2) remote monitoring/reading of power consumption;
3) remote shut off and turn on;
4) alerts to the utility company regarding theft of power at the home level and/or to automatically shut down in response to a theft event;
5) enable the utility company to control consumption at the home level at a per-breaker level;
6) functionality with any broadband over power line (BPL) network, mesh network, or other wired or wireless network; 7) eliminate the need for different meters if the utility company installs more than one communication interface or meter (depends on whether utility company upgrades);
8) act as an open source Gateway into the home or office providing the utility company with additional income sources after a BPL network has been installed; and
9) eliminates labor intensive manual meter reading and associated costs.

In accordance with at least some embodiments, a circuit breaker panel box that operates as breaker/meter Gateway Profit Center is configured to provide one or more of:
1) an open source Gateway into and out of the home or office;
2) an open architecture that adapts to any communications software;
3) software that allows a communications customer such as an Internet provider or telephone provider to connect directly to the circuit breaker panel box or to enable the electric utility company to provide service to the end user;
4) eliminating internal home or office wiring or cabling once the box is connected;
5) enabling an end user to plug a TV or computer into the standard home or office receptacle and receive the communications delivered by the provide;
6) enabling the utility company to profit by using the BPL capability as well as connectivity features of the circuit breaker panel box to third party commercial companies;
7) allowing third party access to the home without wiring inside the home or office (the system allows communications delivery from standard electrical wiring inside the home or office); and
8) supporting remote upgrades from third parties while being completely safe with channel protection which provides a wall between the utility company and any third party application at the home or office level.

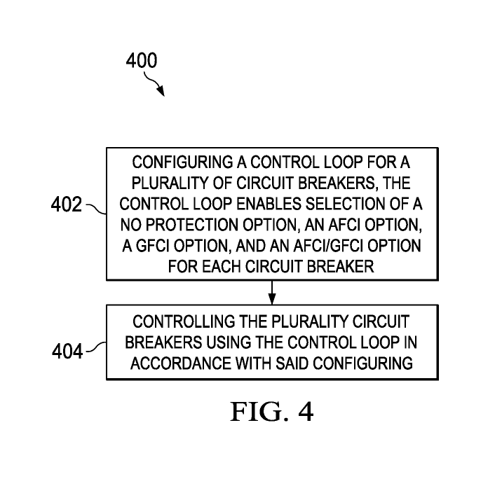

FIG. 4 shows a method 400 in accordance with an embodiment of the disclosure. The method 400 comprises configuring a control loop for a plurality of circuit breakers, where the control loop enables selection of a default protection option, an AFCI protection option, a GFCI protection option, and an AFCI/GFCI protection option (block 402). The method 400 also comprises controlling the plurality of circuit breakers using the control loop in accordance with the previous configuring (block 404).

In at least some embodiments, the method 400 may additionally comprise receiving user input to set each of the plurality of circuit breakers to operate with one of the default tripping option, the AFCI tripping option, the GFCI tripping option, and the AFCI/GFCI tripping option. Additionally or alternatively, the method 400 may comprise receiving communications from a utility provider to remotely monitor and to control the plurality of circuit breakers. Additionally or alternatively, the method 400 may comprise managing home area network (HAN) communication features via the circuit breaker panel. Additionally or alternatively, the method 400 may comprise managing communications between a user and electrical appliances via the circuit breaker panel. Additionally or alternatively, the method 400 may comprise receiving multimedia transmissions via the circuit breaker panel.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention.

What is claimed is:

1. A power delivery system, comprising:
a breaker panel comprising:
a plurality of circuit breakers; and
trip control circuitry coupled to each of the circuit breakers, the trip control circuitry configured to:
receive a trip current value entered by a user for a selected circuit breaker of the plurality of circuit breakers;
receive a current measurement value from the selected circuit breaker; and
cause the selected circuit breaker to trip based on the current measurement value exceeding the trip current value.

2. The system of claim 1, wherein the trip control circuitry is further operable to:
receive a trip time interval value entered by a user for the selected circuit breaker; and
cause the selected circuit breaker to trip based on the current measurement value exceeding the trip current value for at least the trip time interval value.

3. The system of claim 1, further comprising:
a server configured to communicate with the breaker panel;
a controller disposed in the breaker panel, the controller configured to:
selectively authorize access to a portion of the breaker panel identified by authentication information entered by a user; and
provide information to the server identifying changes to the breaker panel made during access to the breaker panel following entry of the authentication information; and
reverse the changes based on an instruction received from the server.

4. The system of claim 1, wherein the breaker panel further comprises a display device and the breaker panel is operable to display on the display device information indicating a cause of a trip of one of the circuit breakers and information indicating whether the trip can be reset.

5. The system of claim 1, wherein the trip control circuitry is operable in response to a trip current value substantially equal to a rated current value of the selected circuit breaker to trip the selected circuit breaker with a trip response time less than a trip response time of actuation components of the circuit breaker.

6. A method of delivering power in a system including a breaker panel having a plurality of circuit breakers and trip control circuitry coupled to each of the circuit breakers, comprising:
providing a trip current value to the trip control circuitry for controlling a selected circuit breaker of the plurality of circuit breakers;
coupling current measurement values from the selected circuit breaker to the trip control circuitry, wherein the trip control circuitry causes the selected circuit breaker to trip when a current measurement value exceeds the current trip value.

7. The method of claim 6, further comprising:
providing a trip time interval value to the trip control circuitry for the selected circuit breaker, wherein the trip control circuitry causes the selected circuit breaker to trip in response to the current measurement value exceeding the trip current value for at least the trip time interval value.

8. The method of claim 6, wherein providing a trip current value comprises providing a trip current value to the control circuitry which is below a rated current of the selected circuit breaker.

9. A circuit breaker panel, comprising:
a plurality of circuit breakers; and
a wireless communications subsystem configured to operate in a mesh-network comprising a plurality of inter-communicating circuit breaker panels.

10. The circuit breaker panel of claim 9, wherein the wireless communications subsystem operates as a cellular base station.

11. The circuit breaker panel of claim 9, further comprising a wireless local area network access point.

12. The circuit breaker panel of claim 10, wherein the cellular base station is operable with in a selected one of a micro-cell and a pico-cell.

13. The circuit breaker panel of claim 10, wherein the wireless communications subsystem is operable to provide communications on a plurality of channels of a wireless local area network.

14. The circuit breaker panel of claim 13, wherein a first channel of the plurality of channels comprises a public channel and a second channel of the plurality of channels comprises a private channel for communicating with a utility company.

15. A circuit breaker panel, comprising:
a plurality of circuit breakers; and
trip control circuitry coupled to the circuit breakers and operable to:
automatically open a switch within a selected circuit breaker of the plurality of circuit breakers in response to a detected condition in a corresponding branch circuit; and
automatically close the switch within the selected circuit breaker in response to a determination that the detected condition is no longer occurring.

16. The circuit breaker panel of claim 15, wherein the trip control circuitry is operable to automatically open the switch within the selected circuit breaker in response to a detection of a condition associated with an arc fault in the corresponding branch circuit.

17. The circuit breaker panel of claim 16, wherein the trip control circuitry is operable to:
analyze a signature of current flow in the branch circuit; and
determine based on the signature of current flow whether an arc fault is occurring in the branch circuit.

18. The circuit breaker panel of claim 15, wherein the trip control circuitry is operable to automatically open the switch within the selected circuit breaker in response to a detection of a condition associated with a ground fault in a corresponding branch circuit.

19. The circuit breaker panel of claim 15, wherein the trip control circuitry is operable to set a time interval for which the switch is open based on a fault detection interval.

20. The circuit breaker panel of claim 15, wherein the trip control circuitry is operable to require manual resetting of the selected circuit breaker in response to a statistical probability that the detected condition is a fault exceeds a predetermined probability threshold.

21. A method of power distribution with a circuit breaker panel including a plurality of circuit breakers and trip control circuitry coupled to the plurality of circuit breakers, comprising:
detecting a condition in a branch circuit;
automatically opening a switch within a corresponding circuit breaker of the plurality of circuit breakers with the trip control circuitry in response to the detected condition; and
automatically closing the switch within the corresponding circuit breaker with the trip control circuitry in response to a determination that the detected condition in the branch circuit is no longer occurring.

22. The method of claim 21, wherein detecting a condition in the branch circuit comprises detecting an arc fault in the branch circuit.

23. The method of claim 21, wherein detecting a fault in a the branch circuit comprises detecting a ground fault in the branch circuit.

24. The method of claim 22, further comprising:
analyzing a signature of current flow in the branch circuit; and
determining based on the signature of current flow whether the detected condition is an arc fault in the branch circuit.

25. The method of claim 21, further comprising setting a time interval for which the switch is open based on a fault detection interval.

26. The method of claim 21, requiring manual resetting of the corresponding circuit breaker with the trip control circuitry in response to a statistical probability that the detected condition is a fault exceeds a predetermined probability threshold.
